(19) United States
(12) Patent Application Publication
(10) Pub. No.: US 2011/0268975 A1
(43) Pub. Date: Nov. 3, 2011

(54) Transient Migrating Phase Low Temperature Joining of Co-Sintered Particulate Materials Including a Chemical Reaction

(75) Inventors: Yuttanant Boonyongmaneerat, Bangkok (TH); Christopher A. Schuh, Ashland, MA (US); Thomas W. Eagar, Belmont, MA (US)

(73) Assignee: Massachusetts Institute of Technology, Cambridge, MA (US)

(21) Appl. No.: 11/795,844

(22) PCT Filed: Jan. 25, 2006
(86) PCT No.: PCT/US06/02699

§ 371 Date: Apr. 11, 2008

Related U.S. Application Data
(60) Provisional application No. 60/646,808, filed on Jan. 25, 2005.

(51) Int. Cl. B32B 17/06

(52) U.S. Cl. 428/433; 428/432

(57) ABSTRACT

A method joins bodies of two component materials, at least one of which is a particulate, at low temperature. A third component has a lower melting point than either of the components. The third component chemically reacts with one or both of the first two to form material with a higher melting point than the original third component. The system is heated to at or above that melting point. The third component melts and flows, migrating to fill spaces between particles. The fluid should migrate to and across the interface, bridging the two component materials. The migrating phase network connects across the joining interface. The reaction product remains solid at temperatures above the original melting point of the third component. The migrating phase can be the liquefied form of the third component, or, a glass, heated to act as a supercooled liquid.

### RELATED DOCUMENT

Priority is claimed to U.S. Provisional application 60/646,808, filed on Jan. 25, 2005, in the names of the present inventors, entitled TRANSIENT LIQUID PHASE BONDING FOR LOWER TEMPERATURE JOINING OF CO-SINTERED MATERIALS. That provisional application is incorporated fully herein by reference.

A partial summary is provided below, preceding the claims.

The inventions disclosed herein will be understood with regard to the following description, appended claims and accompanying drawings, where:

### BRIEF DESCRIPTION OF THE DRAWINGS

FIG. 1 shows test specimens used to test breaking strengths;

FIG. 2 shows, schematically, a setup to bond W and Al₂O₃ powders that are co-sintered at low temperatures, using interlayers of Na₂SiO₃, and W+Al₂O₃, resulting in a migration layer;

FIG. 3 is a digital image of a cross-section of a D-1 specimen, originally having an interlayer of only Na₂SiO₃, after firing, showing a migration layer;

FIG. 4 is a digital image of a SEM cross section of a specimen prepared as at D-2, showing four distinct layers—1) Al₂O₃ layer (top), 2) migration layer of W, Al₂O₃ and infiltrated glass, 3) 85 wt. % W (light particles)+15 wt. % Al₂O₃ (dark particles) layer, and 4) W layer (bottom);

FIG. 5 is a digital image of an enlargement of a portion of a W+Al₂O₃ layer before firing;

FIG. 6 is a digital image of a migration region after firing, where liquid glass has infiltrated into the W+Al₂O₃ layer and a chemical reaction between Na₂SiO₃ and Al₂O₃ has occurred, with the W (light) and Al₂O sintered particles (dark) embedded in the glass matrix;

FIG. 7 shows schematically EDS composition maps of a migration layer, which indicate that dissolution of Al₂O₃ particles into the glass phase has occurred; and

FIG. 8 shows graphically an incomplete phase diagram of Na₂O—Al₂O₃—SiO₂ system showing that as Na₂SiO₃ reacts with Al₂O₃, the global composition of the resultant glass is changed along the line shown in the figure.

### BACKGROUND

In a number of applications, such as coating and metallization, two or more materials are used in contact with one another and are processed by co-sintering of particulate materials. To achieve a satisfactory degree of adhesion along the joining interface using the existing technologies, the sintering and joining processes are typically carried out at relatively high temperatures; for example temperatures above 1500° C. are generally required for bonding tungsten (W) and alumina (Al₂O₃) in the process of W-metallization. In general, the term high temperature processes, as used herein, means processes that take place near to the solidus temperature of at least one major component of the system under study. Inventions disclosed herein relate to joining techniques and compositions useful for bonding co-sintered materials at relatively low temperatures. In one specific example case of co-sintered tungsten and alumina (W and Al₂O₃), temperatures can be as low as 1100-1200° C. with this technique. In general, the term low temperature processes, as used herein, means processes that take place below the solidus temperatures of any major components of the system under study, and in some cases, significantly below.

The W and Al₂O₃ system is a metal-ceramic system used to a great extent, especially in the microelectronics industry and in metal brazing applications. A typical processing route to join the two materials involves slip casting W-containing slurries onto Al₂O₃ substrates, followed by sintering above 1500° C. Such a high temperature is required due to the slow sintering kinetics of the two components, and even at this temperature there is not a chemical reaction between W and Al₂O₃ that promotes bonding. For this reason, it is common to employ bonding strategies involving additives, for example via the so-called Mo—Mn process (Nolte, Note and Spurek; Mattox and Smith) (bibliographic items mentioned herein in parentheses are cited in full, preceding the claims hereof) and the glass migration process Al₂O₃ (Twentyman; Twentyman and Popper). These two techniques rely on the formation and migration of liquid phases at high temperatures, and joints produced by these methods have proven superior to those formed between co-sintered pure W and pure (Varadi and Dominguez; Otsuka).

In the former technique, Mn is usually added to W paint at a weight ratio of 4W:1Mn. Mn will oxidize during sintering in a wet atmosphere and reacts with Al₂O₃, resulting in manganese aluminate spinel (MnAl₂O₄). The spinel thus formed melts during firing and can migrate to the ceramic layer, forming mechanical interlocks upon cooling.

The glass migration process, on the other hand, involves the addition of ceramic materials to Al₂O₃. At certain temperatures depending on the ceramic composition, chemical reaction occurs between different ceramics resulting in a new phase with lower melting point than the starting materials. The new phase thus formed can then liquify and may migrate into the adjacent W layer, providing interface adhesion between the joined materials. While these two conventional processes have been shown to produce materials with strong adhesion, it is required that the processes are carried out at high temperatures, typically above 1500° C. See generally U.S. Pat. No. 4,835,039 (Barringer), U.S. Pat. No. 3,637,435 (Schwyn) and U.S. Pat. No. 4,894,273 (Lieberman).

In addition to these two conventional processes, there are a number of processes that are concerned with modifying the composition of W metallization paint to achieve strong adhesion between W and the substrates as well as to obtain some desirable properties of the W layer. All rely on the processes conducted at high temperatures above 1500° C.

There is prior work that is concerned with bonding of particulate W (or Mo) and solid Al₂O₃, co-sintered at low temperatures. The joining method presented in that work relied on the use of two metal oxides that were mixed into W (or Mo) paint before firing and joining (U.S. Pat. No. 3,403,043, Thompson). Upon sintering, the added metal oxide ceramic powders interact with one another forming a new phase which liquefied and wetted the Al₂O₃ substrate at relatively low temperatures (below 1200° C.), with no chemical reaction between the braze materials and the substrate. A significant disadvantage of this prior technique is that the braze materials can re-melt if the joined materials are used at the temperatures close to the processing temperature, which is low; and the W layer is composed of a high content of ceramic addition which can degrade the desirable properties of W.

While several published works have concentrated on the use of joining techniques performed at high temperatures, low temperature joining processes (for example in the case of the W—Al₂O₃ system, below 1200° C.), have not gained much attention. If the W—Al₂O₃ system could be effectively co-sintered at low temperatures, several benefits would result, including increased productivity, lower energy cost and reduced thermal softening of the components.

To set a baseline for comparison, a set of samples, designated set A, of commercial purity W and alumina were co-sintered at low temperatures. To prepare two-layer joining specimens, W and Al₂O₃ powders were sequentially loaded into a die of rectangular cross-section and cold pressed at 60 MPa. These green specimens were co-fired in a furnace with a heating rate of 5° C./min and an isothermal hold at 1177° C. for one hour, followed by slow furnace cooling. To prevent the oxidation of W, the processing was carried out in a dry 3% H₂-97% N₂ atmosphere. The geometry of each fired specimen was W8.3×L24.7×H5.2 mm (H_{W}=4.5 mm; H_{Al}_{₂}_{O}_{₃}=0.7 mm).

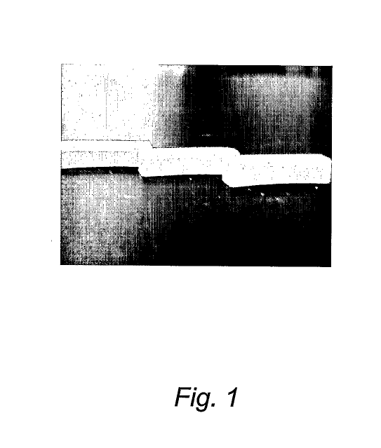

Interfacial strength was evaluated for five specimens, using a four-point bending delamination test. Some typical test specimens are shown in FIG. 1. Each specimen was pre-notched at the middle of the sample in the porous Al₂O₃ layer, using a razor blade. The tests were carried out in a universal testing machine with a crosshead speed of 50 μm/min.

After the sintering cycle, all specimens were intact and no macroscopic interfacial cracks were present. A typical force-displacement curve obtained from the four-point bending delamination tests performed on the fired specimens shows the stages at which interfacial cracks initiate and propagate, as well as the final through-crack failure of the W layer. For a typical sample, crack initiation occurred at about 160 N.

### Set A: W and Al₂O₃

Typical sintered specimens from set A are shown in FIG. 1; these specimens are the baseline for low-temperature co-sintering of the W—Al₂O₃ system, without any joining additives. Observing these specimens in cross-section using SEM shows that both W and Al₂O₃ particles are only very lightly sintered, and a relatively high density of pores are present along the interface. The interfacial delamination occurred in the specimens of set A with an average force of 160 N.

Thus, there is a need for a method to join at least two bodies of material, at least one of which is a particulate, using relatively low temperatures as compared to the melting temperatures of either, but which joined bodies will resist degradation at temperatures above the relatively low joining temperature. There is a particular need for such a method with high solidus temperature materials, such as tungsten (W) and alumina (Al₂O₃). There is additionally a need for such a method that results in a product that can be used at temperatures higher than the melting temperature of any additives that may be used to join the two bodies. Further, if an additive is used, there is a need for such a method that uses only a single additive. In such a case where an additive is used, it is helpful that it be a commercially available material, and further that it not react with or join with either of the two basic materials in a way that degrades their properties.

### DETAILED DESCRIPTION

A general description of an invention hereof is a method of joining of bodies during co-sintering at low temperatures. The method requires two component materials which are to be joined, at least one of which is a particulate or powder material that will undergo sintering during the joining process. Alternatively, both of the component materials to be joined can be particulate or powder materials, which undergo sintering during the joining process. A third component has a lower melting point than either of the two component materials to be joined. Upon heating to above the melting point of the third component, it becomes a fluid, which can migrate due to capillary forces with the particulates or powders in the system. The third component is chosen so that it will chemically react with one or both of the two component materials to be joined. The product of this chemical reaction is a new compound with a higher melting point than the original third component had prior to the reaction.

A joining process of an invention hereof begins when the system is heated to a specified processing temperature that is at or above the melting point of the third component. At the processing temperature, the third component melts, and can flow as a fluid. Due to capillary forces among the powder or particulate components in the system, this fluid will migrate to fill the open space between the powders. In particular, for the joining process to be most effective, the fluid should migrate to the interface, between the two component materials to be joined, and across that interface such that it bridges the two component materials to be joined. Thus, a property of this migrating phase is that it provides a network that connects across the intended joining interface.

Because the third component is reactive with one or both of the two component materials to be joined, during the processing cycle, the fluid phase will react when it contacts the other components. The reaction yields a compound of higher melting point than the third component. Therefore, the reaction product is solid at temperatures above the original melting point of the third component. Thus, the migrating phase becomes a solid phase through this chemical reaction, and this solid phase interpenetrates across the intended joining interface, forming a bond between the two component materials to be joined.

In the above discussion, the migrating phase was the liquefied form of the third component. However, other migrating phases are possible. For example, a glass, when heated above its softening point, acts as a supercooled liquid and can flow and migrate in a similar manner to a fluid. Thus an invention hereof could employ a glass that would constitute the migrating phase.

A chemical reaction takes place during the isothermal joining process of this invention. Thus, the joints produced can be used in service at temperatures above the processing temperature without deterioration of the joint. (A known process that is used to join two solid (non-particulate) bodies, is often called transient liquid phase (TLP) bonding. Processes of invention hereof are called Transient Migrating Phase Bonding (TMPB).)

For the next portion of this discussion, a specific embodiment of the technique for bonding tungsten (W) and alumina (Al₂O₃) is discussed.

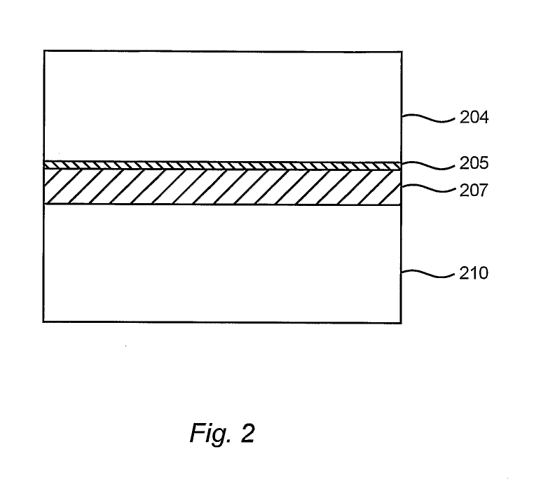

The starting W and Al₂O₃ particulate material can be formed into certain shapes and made to contact one another through many routes, including but not limited to tape casting and cold pressing. A set D-1 of specimens were composed as shown in FIG. 2 of pure W 210 and pure Al₂O₃ 204, with the addition of a glass, sodium metasilicate, Na₂SiO₃ granular powders (300 μm) 205, that were spread uniformly along the metal/ceramic interface prior to the cold pressing step. Relatively large Na₂SiO₃ particles were employed to slow the potential solid state reaction between Na₂SiO₃ and Al₂O₃ upon heating and to promote fluidification of Na₂SiO₃ prior to reaction. (FIG. 2 also shows a layer 207 of mixed alumina and tungsten, which is not present in the embodiment described at this point, but is present in an embodiment described below in connection with specimen set D-2.)

Due to its relatively low melting point of 1089° C., upon heating, Na₂SiO₃ will become flowable, such as by liquifying or vitrifying, at a temperature well below those at which W and Al₂O₃ would liquify, whose melting points are 3410° C. and 2054° C., respectively.

In the present system, there is a potential reaction between Na₂SiO₃ and Al₂O₃, and it is helpful to avoid complete reaction before the Na₂SiO₃ fluidifies. This may be achieved by methods discussed below.

Upon melting, the low melting point compound, which in this example is a glass, (mostly Na₂SiO₃, but possibly containing some Al due to a reaction with Al₂O₃) migrates into the interface and the particulate layer or layers, due to capillary force, and the chemical reaction between Na₂SiO₃, and Al₂O₃ progresses. The final reaction product can have a melting point higher than that of Na₂SiO₃ if the reaction product is rich in Al content (Levin). In this example, the reaction product is also a glass, but it is a different glass from the third material Na₂SiO₃. The region within the W+Al₂O₃ layer at which the fluid glass migrates into the powders will be referred to herein as the glass migration region, in the case of a glass migrating, or, more generally, as the migration region, if the migrating material is not glass. This system offers the potential for a transient migration phase that solidifies after migrating, and remains stable at (and potentially above) the processing temperature. A detailed description of an invention as applied to co-sintered W and Al₂O₃ compacts is described below. Through mechanical evaluation, microstructural examination, and chemical analysis, the joining technique has been successfully reduced to practice.

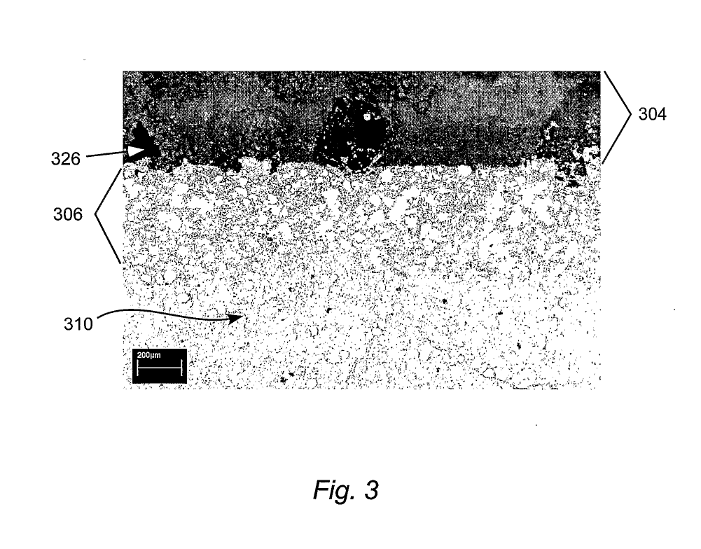

FIG. 3 shows the microstructure of a typical D-1 specimen in cross-section. The W layer 310 is below. A uniform migration layer 306 can be observed clearly below the Al₂O₃ layer 304. Additionally, large pores 326 are present at the places where the Na₂SiO₃ particles (300 μm diameter) were originally located along the interface. When the bend test was performed on D-1 specimens, no interfacial delamination occurred, with through-cracking occurring at the maximum load of 400N.

To further investigate aspects of inventions hereof, a similar sample D-2 was prepared, as set forth in the following table.

TABLE
Ceramic and metal compositions of various specimen sets

| | Ceramic | Metal Composition | |
|---|---|---|---|
| Specimen | Composition | [wt. %] | |
| Sets | Al₂O₃ | W | Interlayers |
| D-1 | 100 | 100 | Na₂SiO₃ |
| D-2 | 100 | 100 | Na₂SiO₃85W + 15Al₂O₃ |

An additional layer 207 of material, which is composed of a mixture of W and Al₂O₃, is introduced between the W 210 and Al₂O₃ 204 layers (FIG. 2). A third material, for example, the same additive of a glass discussed above, sodium metasilicate (Na₂SiO₃, in the form of particles in this case) is then applied along the interface 205 between the W+Al₂O₃ 207 and Al₂O₃ layers 204.

Test specimens were prepared in the form of multi-layer sintered compacts of the same type as are discussed above, as shown in FIG. 1. In particular, 9.5 g of W powders (2 μm), 1 g of 85 wt % W-15 wt % Al₂O₃ pre-mixed powders, 0.04 g of Na₂SiO₃ granular powders (300 μm), and 0.7 g of Al₂O₃ powders (8 μm) were sequentially filled into a die and cold pressed at 60 MPa. The geometry of each green specimen was W8.4 mm×L25.0 mm×H4.4 mm. The specimens were then co-sintered by co-firing in a furnace with a heating rate of 5° C./min and isothermal hold at 1177° C. for 1 hour, followed by slow furnace cooling. To prevent the oxidation of W, the processing was carried out in a 3% H₂-97% N₂ atmosphere.

Following processing, the interfacial strength of each specimen was evaluated with a common four-point bending delamination test. For comparison, the test specimens as at A above were prepared from W/Al₂O₃ co-sintered specimens processed without the addition of the Na₂SiO₃ and W+Al₂O₃ layer. Interfacial delamination occurred at an applied force of 160N. In contrast, for the specimens joined with a technique disclosed herein as at D-2, no delamination occurred during the tests (287N maximum load); the interface was stronger than the body strength in these specimens. These results indicate that the interfacial strength of the system is improved substantially with the disclosed technique.

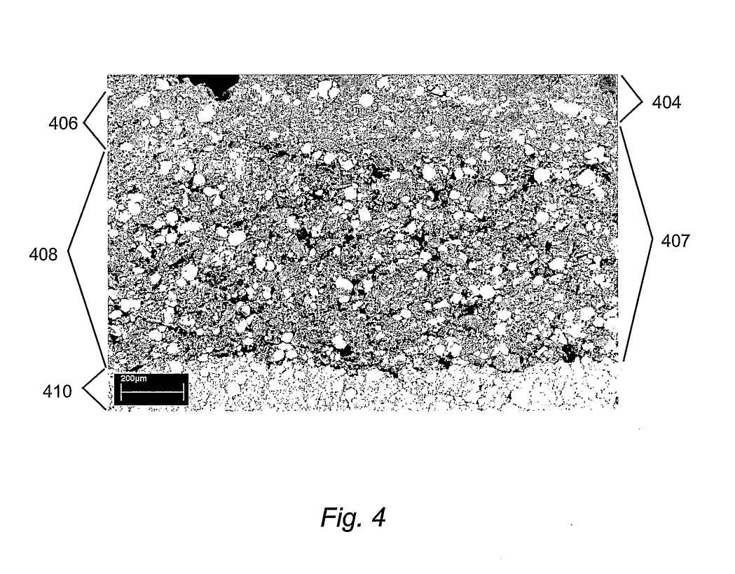

A SEM (scanning electron microscopy) micrograph shown in FIG. 4 illustrates a cross section of a D-2 specimen prepared with a disclosed technique. Four distinct regions can be clearly observed from the micrograph: Al₂O₃ 404: migration 406; W+Al₂O₃ 408; and W 410. The migration region layer 406 with a thickness of about 200 μm is present within the region 407, which, prior to firing, was originally composed of a mixture of W and Al₂O₃, just below the Al₂O₃ layer 404.

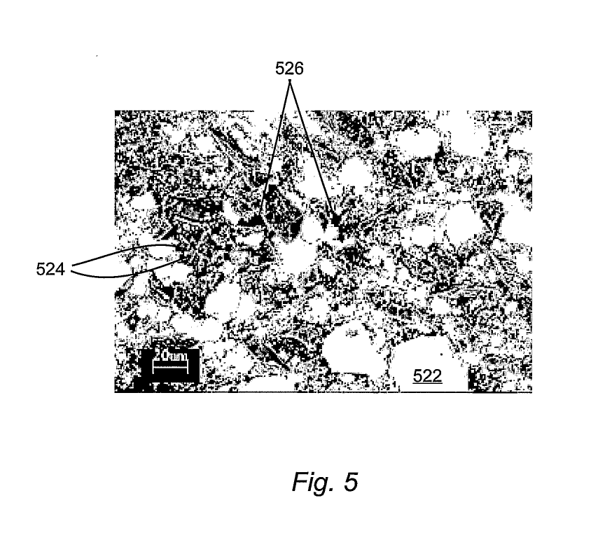

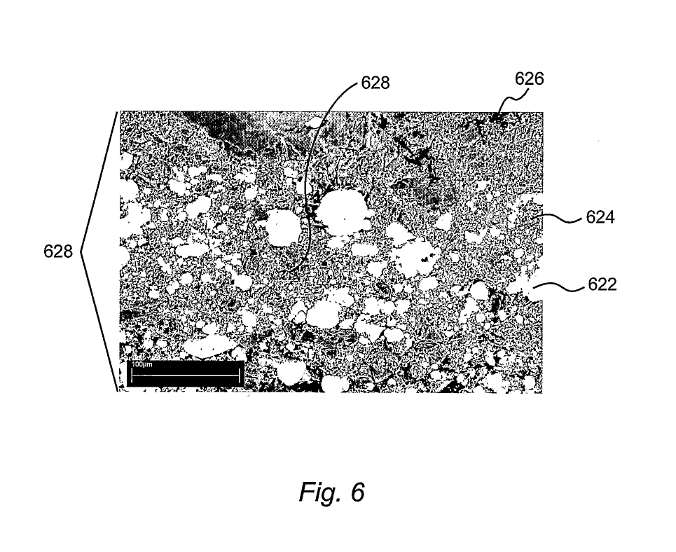

FIGS. 5 and 6 show the microstructure of the W+Al₂O₃ layer, with the composition shown in FIG. 5 corresponding roughly to the composition of the region 407 before firing, and the composition shown in FIG. 6 corresponding roughly to the composition of the region 406, after the chemical reaction between Na₂SiO₃ and Al₂O₃ took place. In FIG. 5, W 522 (light) and Al₂O₃ (dark) 524 particles can be observed. Because the system is processed at low firing temperature, and W and Al₂O₃ are refractory, sintering is incomplete, and pores 526 can be observed throughout. In contrast to FIG. 5, FIG. 6 shows that after processing, pores 626 in the structure have been closed by the glass infiltration. Light regions 622 are predominantly W and dark regions 624 are predominantly Al₂O₃.

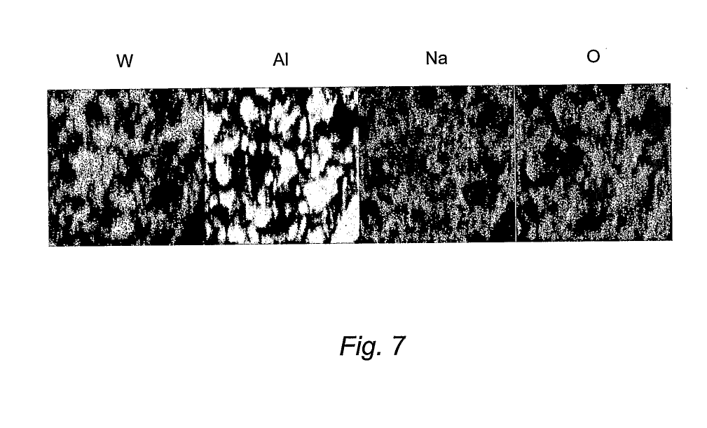

EDS (energy dispersive spectroscopy) composition maps of the specimen in the region of glass migration are shown in FIG. 7. The results obtained from the EDS spatial distribution analyses show that Al₂O₃ particles were partially dissolved into the migrating Na₂SiO₃ phase, which formed a dense and contiguous matrix 628 shown on FIG. 6 around the particles of the interlayer, leading to the chemical reaction between Na₂SiO₃ and Al₂O₃.

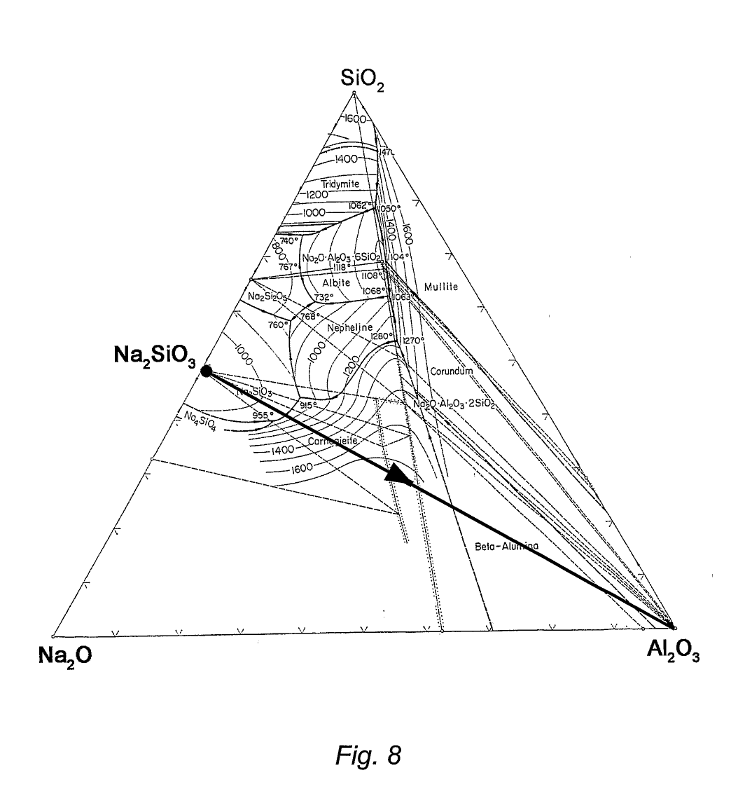

An incomplete phase diagram of the Na₂O—Al₂O₃—SiO₂ system is shown in FIG. 8 (Levin). As Al₂O₃ diffused into and reacted with Na₂SiO₃, the composition of the migrating phase changes progressively along the composition line illustrated in FIG. 8 in bold with an arrow. In particular, the content of Al and O would be increased, relative to that of Na and Si. Examination of the composition of the glass in the migration region 406 with EDS, showed that the average Al₂O₃-to-Na₂O.SiO₂ ratio was about 5:4 (atomic fraction). The melting point of the compound with any certain composition can be read from the diagram in FIG. 8. The 5:4 composition constitutes a compound with a melting point above 1600° C. However, it was produced at temperatures below 1200° C.

A more formal description of events is that, upon heating, Sodium silicate (Na₂SiO₃) will fluidify and alumina in the system starts to diffuse into the liquid glass. According to the phase diagram of the Na₂O—SiO₂—Al₂O₃ system, shown in FIG. 8, the main reaction product includes Carnegieite (Na₂O.Al₂O₃.2SiO₂).

The inventors have measured the global compositions of Al₂O₃ and Na₂SiO₃ in the glass at room temperature and found that the glass is rich in Al₂O₃ content. This constitutes glass with a relatively high solidus temperature of around 1500° C. and a liquidus temperature of about 1700° C.

This result highlights the potential value of Na₂SiO₃ to form a transient migrating phase. Although it becomes flowable, migrates, and promotes interlocking and bonding during low temperature (<1200° C.) firing, it also simultaneously reacts with Al₂O₃ to form a stable solid compound at higher temperatures (>1500° C.). Given an optimum interlayer geometry and processing history, joints formed by this transient migrating phase penetration bonding co-sintering method may retain appreciable strength even in service above the processing temperature.

Several techniques slow the kinetics of reaction between Na₂SiO₃ and Al₂O₃, if desired, including: using relatively large Na₂SiO₃ powders, using a relatively thick layer of Na₂SiO₃ powders, or using relatively large Al₂O₃ powders. Alternatively, the Al₂O₃ can be precoated with a layer that inhibits but does not stop diffusion, e.g. a layer of SiO₂ on the Al₂O₃ will delay the reaction of the Al₂O₃ and Na₂SiO₃ without stopping the reaction completely.

In the D-2 example, with the mixed layer of W+Al₂O₃, the body strength of the system (287N) is rather low, as compared to specimens from set D-1 (470N). This is attributed to the relatively large uninfiltrated interlayer 408 of mixed W+Al₂O₃ that was not infiltrated with a migrating phase during firing (FIG. 4). In an optimized system, the interlayer 407, that had been W+Al₂O₃ prior to firing, would be fully infiltrated with the migrating phase, leaving no uninfiltrated region 408 after processing, improving the body strength of the system.

### Commercial Applications

The disclosed inventions may be applied to several commercial applications where there is the need or the advantage to join two co-sintered materials at low temperatures.

These inventions can be applied to produce electronic packages, which are composed of metallized circuit patterns and ceramic substrates, at low temperatures. Instead of cold pressing as given as an example in this disclosure, the materials may advantageously be processed by slip casting for this particular application.

W-metallization on Al₂O₃ is also employed to assist the metal-ceramic brazing process. Since commercially available brazes do not wet ceramic surfaces well, W can be applied on ceramics to be joined and thus help improve the wetting characteristics at the surfaces.

Coating of W layers onto Al₂O₃ substrates or vice versa can also be utilized for reaction barriers, or for composite structures requiring the low thermal diffusivity of Al₂O₃ combined with the refractory properties of a W surface.

Some modifications of using Na₂SiO₃ to join W and Al₂O₃ co-sintered at low firing temperatures are possible, as listed below. It should be noted that the joined products processed with some of these methods may not be used at the temperatures above the melting point of Na₂SiO₃, because some portion of Na₂SiO₃ in the system may remain unreacted with Al₂O_{3.}

Other materials that forms a glass matrix phase as a reaction product with at least one of the two component materials can be used instead of Na₂SiO₃.

Na₂SiO₃ may be mixed into the W layer alone, or the Al₂O₃ layer alone, or into both W and Al₂O₃ layers.

Instead of W, other materials can be used, including but not limited to Mo, Nb (niobium), Ni (nickel), Ta (tantalum) and Pt (platinum), which can be used either as pure elements, or as alloys with any of the others, or with suitably inert materials. In general refractory metals are candidates for a metal of the system.

Some additives, such as Ni and SiO₂, can be mixed into W and Al₂O₃, respectively, to speed up the sintering kinetics of the materials.

The Al₂O₃ layer can be pre-sintered before the application of Na₂SiO₃, W+Al₂O₃ and W layers, respectively.

A base material different from Al₂O₃ can be used, including, but not limited to ZrO₂ (stabilized zirconia) and CaO (calcium oxide).

With the joining technique presented in this disclosure, W and Al₂O₃ can be co-sintered and joined at relatively low temperatures. Different from the known techniques, joining techniques of inventions hereof rely on the addition of only one third material, such as Na₂SiO₃, which is commercially available. The formation of a reaction phase with a high melting point during the isothermal process allows the joined materials to withstand high service temperatures. Additionally, the process can be controlled such that W in the W layer remains pure throughout the process.

### General Matters

An invention hereof has been discussed above in connection with a W and Al₂O₃ example, where a third material, in the form of a glass Na₂SiO₃ is added, which fluidifies at a relatively low temperature, flows between the regions of W and Al₂O₃ and chemically reacts with the Al₂O₃, to form a different material, also a glass, which has a solidus temperature that is much higher than the temperature of the reaction at which it was formed. Other forms of an invention hereof are possible.

In a general expression of an invention hereof, a process is for joining two bodies, at least one of which is composed of particulate materials. A third material is physically brought in contact so that upon heating, the third material fluidifies, either becoming liquid, vitreous, or viscous, to a degree that it flows, and migrates throughout a region of the particulate material of the body, and then chemically reacts with one or both of the materials of the two bodies, to form a reaction product. The reaction product has a melting temperature that is higher than that of the third material. The particulate material also undergoes sintering or densification during the process. Thus, the joined body can be used at temperatures that are higher than the temperature of reaction at which it was formed.

The composition of the materials can be anything that satisfies these general conditions. One or both of the original two materials can be metal. One or both can be a ceramic. The third material can be a glass, or a material that forms a glass upon reaction. Or, it can be a glass that forms a different glass upon reaction. Or, it can be a material that does not become glass, but becomes liquid upon heating and then forms a solid, or a glass upon reaction. Or, to the extent that a material may flow without being liquid or glass, the third material may be any material that flows under conditions that then give rise to a chemical reaction with at least one of the two host materials, which forms a product that is solid at temperatures higher than the temperature of the reaction that formed it.

The migration of the fluid material spreads the joining phase out among the particulate materials, and helps to increase the region that is bonded, as compared, for instance, to joining between two solid bodies with a glass interlayer.

The third material can be provided as a pure layer between the particulate body and the other body, or it can be mixed within all or a part of the at least one, particulate body or both if both are particulate.

The third material may be a pure, or relatively pure element, a compound, or a mixture of more than one elements or compounds.

More than one interface can be joined in this manner. For instance, a structure can be made that is a sandwich, with a first particulate material in the center between two layers of the second material, with a layer of the third material at each of the two interfaces. Or, the particulate material may be on the outsides of the sandwich. The interfaces may be between identical pairs of material, with the same third material, or different pairs of material, and with different, so-called, third materials. More than three layers can be used, as long as a suitable mechanical support and firing sequence can be devised.

The regions and their interfaces need not be planar layers, or smooth. The interface between the regions may be complex. For instance, layers of particulate material may be provided such as by the techniques disclosed in U.S. Pat. No. 6,596,224, entitled JETTING LAYERS OF POWDER AND THE FORMATION OF FINE POWDER BEDS THEREBY, which is incorporated fully herein, by reference, in which three dimensional bodies of particulate material with complex shapes, are built up by jetting streams of slurry.

### Partial Summary

Inventions disclosed and described herein include bodies with a specified structure, joined bodies, plated, and covered bodies, methods of making bodies, methods of joining bodies and methods of plating and covering bodies.

Thus, this document discloses many related inventions.

One invention disclosed herein is a body comprising a first region of an alumina material, a second region of a metal material, at least one of the alumina and the metal materials being derived at least in part from particulate material that has densified; and a continuous glass phase, between and contacting the first and second regions of material. The glass phase penetrates at least in part, into at least the region of material that is derived from particulate material. The glass comprises a chemical reaction product of: a third material that differs from the alumina and the metal; and at least one of the alumina material and the metal. For an important related embodiment, the glass comprises a product of a chemical reaction that takes place at a reaction temperature that is less than, and in some cases, significantly less than any solidus temperature of each of: the alumina, the metal, and the glass.

Stated slightly differently, the body consists of materials that all have a solidus temperature that is higher, and in some cases, significantly higher, than the temperature of the reaction at which the glass forms.

According to one embodiment, both the material of the first region and the material of the second region comprise material that is derived from particulate material. The particulate material may be loose, are partially or fully sintered.

The glass may comprise a continuous phase that penetrates at least in part, the second region of material or the first region of material, or both.

With a related group of embodiments, the metal may comprise a metal selected from the group consisting of: titanium, molybdenum, niobium, tantalum, platinum, nickel and any alloy based upon any of the foregoing.

The third material may comprise Na₂SiO₃ or any other glass matrix forming material.

Still another useful embodiment further comprises a region of mixed material, adjacent the metal region, and between the metal region and the alumina region, which mixed material comprises a material that is derived from a mixture of particulate alumina of the first region and particulate metal of the second region, and which region of mixed material is penetrated at least in part and in some cases through its entire thickness, by the continuous glass phase.

Either or both the second and the first regions may also comprise the glass phase.

With a related embodiment, the alumina layer may further comprise silicon dioxide (SiO₂).

Still another embodiment is a body comprising: a first region of a first material; a second region of a second material, at least one of the first and the second materials being derived at least in part from particulate material that has densified; and a continuous solid phase, between and contacting the first and second regions of material. The solid phase penetrates at least in part, into at least the region of material that is derived from particulate material. The solid phase comprises a chemical reaction product of: a third material that differs from the first material and the second material; and at least one of the first material and the second material.

For a significant related embodiment, the solid phase comprises a product of a chemical reaction that takes place at a reaction temperature that is less than, and in many cases, significanatly less than, any solidus temperature of each of: the first material, the second material, and the solid phase material.

As above, this can be understood slightly differently considering the related embodiment consisting of materials, all having a solidus temperature that is higher, and in some cases, significantly higher, than the temperature of the reaction at which the solid phase forms.

Variations of a related embodiment have one or both the material of the first region and the material of the second region comprising material that is derived from particulate material. This may be either loose, or lightly, or fully sintered.

The solid phase may comprise a continuous phase that penetrates at least in part, the first or second region of material or both.

The second material may advantageously comprise a metal selected from the group consisting of: titanium, molybdenum, niobium, tantalum, platinum and nickel and any alloy based on any of the foregoing. Alternatively, the metal may be selected from among many refractory metals.

The third material comprises a suitable solid phase forming material, such as a glass matrix forming material, such as Na₂SiO₃.

A similar embodiment, further comprises a region of mixed material, adjacent the second region, and between the second region and the first region, which mixed material comprises a material that is derived from a mixture of particulate first material of the first region and particulate second material of the second region, and which region of mixed material is penetrated at least in part by the continuous solid phase. With this embodiment, the solid phase penetrates completely through the entire thickness of the region of mixed material and penetrates at least partially into the second region. Either the first or the second regions may comprise the solid phase.

The first material may comprise a material selected from the group consisting of silicon dioxide (SiO₂) and alumina (Al₂O₃).

Yet another embodiment of an invention hereof is a method for fabricating a body comprising the steps of: providing in a first region, an alumina material; providing, in a second region, a metal material, at least one of the metal and the alumina comprising particulate material; and providing, between and contacting the first and second regions of material, a third material that differs from the alumina and the metal, which will chemically react at a reaction temperature with at least one of the alumina and the metal, to form a glass. Conditions are maintained, including temperature, such that the third material forms a first glass phase and migrates and penetrates at least the region of particulate material, and a chemical reaction occurs with the third material and at least one of the alumina and the metal, to form a continuous second glass phase that penetrates at least the region of material that is particulate; and the at least one particulate material sinters.

For a related embodiment, the step of providing a third material comprises providing a material that will react with the alumina to form a glass that has a solidus temperature that is higher, and in many cases, significantly higher, than the reaction temperature at which the glass is formed.

The step of providing an alumina material may be by providing a particulate material, either loose or sintered, completely, or partially.

With one similar embodiment, the step of maintaining conditions comprises maintaining conditions such that a chemical reaction occurs among the third material and both the metal and the alumina material. The third material may be a glass.

Still another embodiment further comprising the step of providing, between and contacting the third region of material, and at least one of the first and second regions of material, a region of material that comprises a mixture of the alumina and the metal in particulate form, and the step of maintaining conditions comprises maintaining conditions such that the first glass phase migrates and penetrates the region of mixed metal and alumina material.

Another important embodiment is further wherein the step of providing the third material comprises providing the third material in particulate form, which is mixed with at least one of the metal and the alumina, which is also in particulate form.

A related, perhaps more general expression of an invention hereof is a method of fabricating a body comprising the steps of: providing, in a first region a first material; providing, in a second region, a second material, at least one of the first and the second materials comprising particulate material; and providing, between and contacting the first and second regions of material, a region with a third material, which differs from the first and the second materials, which will chemically react at a reaction temperature with at least one of the first and the second materials to form a fourth material. Conditions are maintained, including temperature, such that: the third material forms a continuous fluid phase and migrates and penetrates into at least the region of material that is particulate and a chemical reaction occurs with the third material and at least one of the first and the second materials, to form a continuous phase of the fourth material, that penetrates at least into the region of material that is particulate; and the at least one particulate material sinters.

With a very useful embodiment of a method invention hereof, the step of providing a third material comprises providing a material that fluidifies and reacts with the at least one of the first and second materials at the reaction temperature, to form the fourth material, a glass that has a solidus temperature that is higher than, and in many cases, significantly higher than, the reaction temperature at which the fourth material forms.

An embodiment that is similar to some of the above embodiments further comprises the step of providing between the region with the third material and one of the regions of the first and second materials, a region that comprises a mixture of particles of the first and second materials.

Both the first and second materials may comprise particulate materials, which may be loose, or sintered, either fully or partially.

Still another embodiment of an invention hereof is a method of joining two bodies of particulate materials, comprising the steps of: providing a first body comprising a first particulate material; providing a second body comprising a second particulate material; and providing, between and contacting the first and second bodies, a third material, which differs from the first and the second materials, which will chemically react at a reaction temperature with at least one of the first and the second materials to form a fourth material. Conditions are maintained, including temperature, such that: the third material forms a continuous fluid phase and migrates and penetrates at least partially into at least one of the first and second bodies and a chemical reaction occurs with the third material and at least one of the first and the second materials, to form a continuous phase of the fourth material which continuous phase penetrates at least partially across the interface between the first and second bodies and at least one of the first and second particulate materials sinters.

It is advantageous if the fourth material has a solidus temperature that is higher than the temperature at which the reaction occurs.

Yet another embodiment of an invention hereof is a method of providing a metal covering on a ceramic body comprising the steps of: providing a body comprising a ceramic material; providing a metal material, at least one of the metal and the ceramic materials being in a particulate form; contacting the ceramic body at locations to be covered with a joining material, which differs from the ceramic and the metal materials, which joining material will chemically react at a reaction temperature with at least one of the ceramic and metal materials to form a fourth material; and contacting the metal material to the ceramic body at the locations to be covered, at which the joining material is present. Conditions are maintained, including temperature, such that: the joining material forms a continuous fluid phase and migrates and penetrates at least partially at least one of the ceramic body and metal material and a chemical reaction occurs with the joining material and at least one of the ceramic body and the metal material, to form a continuous phase of a fourth material, that penetrates at least partially across the interface between the ceramic body and the metal material; and the at least one particulate material sinters. As with many embodiments discussed above, the fourth material may have a solidus temperature that is higher and in many cases, significantly higher, than the temperature at which the reaction occurs. Either the metal or the ceramic may comprise particulate material.

Even another important embodiment of an invention hereof is a method of providing a ceramic covering on a metal body comprising the steps of: providing a body comprising a metal material; providing a ceramic material, at least one of the metal and the ceramic materials being in a particulate form; contacting the metal body at locations to be covered with a joining material, which differs from the ceramic and the metal materials, which joining material will chemically react at a reaction temperature with at least one of the ceramic and metal materials to form a fourth material; and contacting the ceramic material to the metal body at the locations to be covered, at which the joining material is present. Conditions are maintained, including temperature, such that: the joining material forms a continuous fluid phase and migrates and penetrates at least partially at least one of the metal body and ceramic material and a chemical reaction occurs with the joining material and at least one of the metal body and the ceramic material, to form a continuous phase of a fourth material, that penetrates at least partially across the interface between the metal body and the ceramic material; and the at least one particulate material sinters. Again, the fourth material may have a solidus temperature that is higher and in many cases, significantly higher, than the temperature at which the reaction occurs. Either the metal or the ceramic may comprise particulate material.

Many techniques and aspects of the inventions have been described herein. The person skilled in the art will understand that many of these techniques can be used with other disclosed techniques, even if they have not been specifically described in use together. For instance, the techniques described with a material that forms a glass continuous phase can be used with materials that form other solid phases. The techniques that have been described for joining two bodies together can be used for plating metal on ceramic, or ceramic on metal, or other materials as both plating and body.

This disclosure describes and discloses more than one invention. The inventions are set forth in the claims of this and related documents, not only as filed, but also as developed during prosecution of any patent application based on this disclosure. The inventors intend to claim all of the various inventions to the limits permitted by the prior art, as it is subsequently determined to be. No feature described herein is essential to each invention disclosed herein. Thus, the inventors intend that no features described herein, but not claimed in any particular claim of any patent based on this disclosure, should be incorporated into any such claim.

Some assemblies of hardware or compositions of matters, or groups of steps, maybe referred to herein as an invention. However, this is not an admission that any such assemblies or groups are necessarily patentably distinct inventions, particularly as contemplated by laws and regulations regarding the number of inventions that will be examined in one patent application, or unity of invention. It is intended to be a short way of saying an embodiment of an invention.

An abstract is submitted herewith. It is emphasized that this abstract is being provided to comply with the rule requiring an abstract that will allow examiners and other searchers to quickly ascertain the subject matter of the technical disclosure. It is submitted with the understanding that it will not be used to interpret or limit the scope or meaning of the claims, as promised by the Patent Office's rule.

The foregoing discussion should be understood as illustrative and should not be considered to be limiting in any sense. While the inventions have been particularly shown and described with references to preferred embodiments thereof, it will be understood by those skilled in the art that various changes in form and details may be made therein without departing from the spirit and scope of the inventions as defined by the claims.

### BIBLIOGRAPHIC ITEMS

R. R. Tummala, “Ceramics in microelectronic packaging,” American Ceramic Society Bulletin, vol. 67, pp. 752-58, 1988.

W. H. Kohl, “Ceramics and Ceramic-to-Metal Sealing,” Vacuum, vol. 14, pp. 333-354, 1964.

E. M. Levin, C. R. Robbins, and H. F. McMurdie, “Phase Diagrams for Ceramists,” vol. 1: The American Ceramic Society, INC, 1964, pp. 501.

P. F. Varadi and R. Dominguez, “Tungsten Metallizing of Ceramics,” American Ceramic Society Bulletin, vol. 9, 1966.

Nolte, U.S. Pat. No. 2,667,432 1954.

H. J. Nolte and R. F. Spurek, “Metal-Ceramic Sealing with Manganese,” Television Engr., vol. 1, pp. 14-18, 1954.

D. M. Mattox and H. D. Smith, “Role of Manganese in the Metalization of High Alumina Ceramics,” American Ceramic Society Bulletin, vol. 64, pp. 1363-67, 1985.

M. E. Twentyman, “High-Temperature Metallizing: Part 1. The Mechanism of Glass Migration in the Production of Metal-Ceramic Seals,” Journal of Materials Science, vol. 10, pp. 765-76, 1975.

M. E. Twentyman and P. Popper, “High-Temperature Metallizing: Part 2. The Effect of Experimental Variables on the Structure of Seals to Debased Aluminas,” Journal of Materials Science, vol. 10, pp. 777-90, 1975.

K. Otsuka, T. Usami, and M. Sekihata, “Interfacial Bond Strength in Alumina Ceramics Metallized and Cofired with Tungsten,” American Ceramic Society Bulletin, vol. 60, pp. 540-5, 1981.

Barringer, U.S. Pat. No. 4,835,039 1989.

Schwyn, U.S. Pat. No. 3,637,435 1972.

Lieberman, U.S. Pat. No. 4,894,273 1990.

S. P. Thompson, U.S. Pat. No. 3,403,043 1968.

The corresponding structures, materials, acts and equivalents of all means or step plus function elements in the claims below are intended to include any structure, material, or acts for performing the functions in combination with other claimed elements as specifically claimed.

What is claimed is:

1. A body comprising:
a. a first region of an alumina material;
b. a second region of a metal material, at least one of the alumina and the metal materials being derived at least in part from particulate material that has densified; and
c. a continuous glass phase, between and contacting the first and second regions of material, which glass phase penetrates at least in part, into at least the region of material that is derived from particulate material, the glass comprising a chemical reaction product of: a third material that differs from the alumina and the metal; and at least one of the alumina material and the metal.

2. The body of claim 1, the glass comprising a product of a chemical reaction that takes place at a reaction temperature that is less than any solidus temperature of each of: the alumina, the metal, and the glass.

3. The body of claim 1, the glass comprising a product of a chemical reaction that takes place at a reaction temperature that is significantly less than any solidus temperature of each of: the alumina, the metal, and the glass.

4. The body of claim 2, consisting of materials, all having a solidus temperature that is higher than the temperature of the reaction at which the glass forms.

5. The body of claim 2, consisting of materials having a solidus temperature that is significantly higher than the temperature of the reaction at which the glass forms.

6. The body of claim 1, wherein both the material of the first region and the material of the second region comprise material that is derived from particulate material.

7. The body of claim 1, further where the glass comprises a continuous phase that penetrates at least in part, the second region of material.

8. The body of claim 1, the metal comprising a metal selected from the group consisting of: titanium, molybdenum, niobium, tantalum, platinum and nickel.

9. The body of claim 1, the metal comprising a metal selected from the group consisting of: titanium, molybdenum, niobium, tantalum, platinum, nickel and any alloy based upon any of the foregoing.

10. The body of claim 1, the third material comprising Na₂SiO₃.

11. The body of claim 1, the third material comprising a glass matrix forming material.

12. The body of claim 1, further comprising a region of mixed material, adjacent the metal region, and between the metal region and the alumina region, which mixed material comprises a material that is derived from a mixture of particulate alumina of the first region and particulate metal of the second region, and which region of mixed material is penetrated at least in part by the continuous glass phase.

13. The body of claim 12, the continuous glass phase penetrating completely through the entire thickness of the region of mixed material and penetrating at least partially into the metal region.

14. The body of claim 1, the second region further comprising the glass.

15. The body of claim 1, the first region further comprising the glass.

16. The body of claim 1, the first and second regions further comprising the glass.

17. The body of claim 1, the alumina layer further comprising silicon dioxide (SiO₂).

18. A body comprising:
a. a first region of a first material;
b. a second region of a second material, at least one of the first and the second materials being derived at least in part from particulate material that has densified; and
c. a continuous solid phase, between and contacting the first and second regions of material, which solid phase penetrates at least in part, into at least the region of material that is derived from particulate material, the solid phase comprising a chemical reaction product of: a third material that differs from the first material and the second material; and at least one of the first material and the second material.

19. The body of claim 18, the solid phase comprising a product of a chemical reaction that takes place at a reaction temperature that is less than any solidus temperature of each of: the first material, the second material, and the solid phase material.

20. The body of claim 18, the solid phase comprising a product of a chemical reaction that takes place at a reaction temperature that is significantly less than any solidus temperature of each of: the alumina, the metal, and the solid phase material.

21. The body of claim 19, consisting of materials, all having a solidus temperature that is higher than the temperature of the reaction at which the solid phase forms.

22. The body of claim 19, consisting of materials having a solidus temperature that is significantly higher than the temperature of the reaction at which the solid phase forms.

23. The body of claim 18, wherein both the material of the first region and the material of the second region comprise material that is derived from particulate material.

24. The body of claim 18, further where the solid phase comprises a continuous phase that penetrates at least in part, the second region of material.

25. The body of claim 18, the second material comprising a refractory metal.

26. The body of claim 18, the second material comprising a metal selected from the group consisting of: titanium, molybdenum, niobium, tantalum, platinum and nickel.

27. The body of claim 18, the second material comprising a metal selected from the group consisting of: titanium, molybdenum, niobium, tantalum, platinum, nickel and any alloy based on any of the foregoing.

28. The body of claim 18, the third material comprising Na₂SiO₃.

29. The body of claim 18, the third material comprising a glass matrix forming agent.

30. The body of claim 18, further comprising a region of mixed material, adjacent the second region, and between the second region and the first region, which mixed material comprises a material that is derived from a mixture of particulate first material of the first region and particulate second material of the second region, and which region of mixed material is penetrated at least in part by the continuous solid phase.

31. The body of claim 30, the solid phase penetrating completely through the entire thickness of the region of mixed material and penetrating at least partially into the second region.

32. The body of claim 18, the second region further comprising the solid phase.

33. The body of claim 18, the first region further comprising the solid phase.

34. The body of claim 18, the first and second regions further comprising the solid phase.

35. The body of claim 18, the first material comprising a material selected from the group consisting of silicon dioxide (SiO₂) and alumina (Al₂O₃).

36. A method of fabricating a body comprising the steps of:
a. providing, in a first region, an alumina material;
b. providing, in a second region, a metal material, at least one of the metal and the alumina comprising particulate material;
c. providing, between and contacting the first and second regions of material, a third material that differs from the alumina and the metal, which will chemically react at a reaction temperature with at least one of the alumina and the metal, to form a glass; and
d. maintaining conditions, including temperature, at conditions such that:
i. the third material forms a first glass phase and migrates and penetrates at least the region of particulate material, and a chemical reaction occurs with the third material and at least one of the alumina and the metal, to form a continuous second glass phase that penetrates at least the region of material that is particulate; and
ii. the at least one particulate material sinters.

37. The method of fabricating a body of claim 36, wherein the step of providing a third material comprises providing a material that will react with the alumina to form a glass that has a solidus temperature that is higher than the reaction temperature at which the glass is formed.

38. The method of claim 36, wherein both the alumina and the metal comprise particulate material.

39. The method of claim 36, wherein the step of maintaining conditions comprises maintaining conditions such that a chemical reaction occurs among the third material and both the metal and the alumina material.

40. The method of claim 36, wherein the third material comprises a first glass.

41. The method of claim 36, further wherein the step of providing alumina material comprises providing loose particulate material.

42. The method of claim 36, further wherein the step of providing alumina material comprises providing at least partially sintered particulate material.

43. The method of claim 36, further comprising the step of providing, between and contacting the third region of material, and at least one of the first and second regions of material, a region of material that comprises a mixture of the alumina and the metal in particulate form, and the step of maintaining conditions comprises maintaining conditions such that the first glass phase migrates and penetrates the region of mixed metal and alumina material.

44. The method of claim 36, further wherein the step of providing the third material comprises providing the third material in particulate form, which is mixed with at least one of the metal and the alumina, which is also in particulate form.

45. A method of fabricating a body comprising the steps of:
a. providing, in a first region a first material;
b. providing, in a second region, a second material, at least one of the first and the second materials comprising particulate material;
c. providing, between and contacting the first and second regions of material, a region with a third material, which differs from the first and the second materials, which will chemically react at a reaction temperature with at least one of the first and the second materials to form a fourth material; and
d. maintaining conditions, including temperature, at conditions such that:
i. the third material forms a continuous fluid phase and migrates and penetrates into at least the region of material that is particulate and a chemical reaction occurs with the third material and at least one of the first and the second materials, to form a continuous phase of the fourth material that penetrates at least into the region of material that is particulate; and
ii. the at least one particulate material sinters.

46. The method of fabricating a body of claim 45, wherein the step of providing a third material comprises providing a material that fluidifies and reacts with the at least one of the first and second materials at the reaction temperature, to form the fourth material, a glass that has a solidus temperature that is higher than the reaction temperature at which the fourth material forms.

47. The method of fabricating a body of claim 45, further comprising the step of providing between the region with the third material and one of the regions of the first and second materials, a region that comprises a mixture of particles of the first and second materials.

48. The method of claim 45, wherein both the first and second materials comprise particulate material.

49. The method of claim 45, wherein the step of maintaining conditions comprises maintaining conditions such that a chemical reaction occurs among the third material and both the first and the second materials.

50. A method of joining two bodies of particulate materials, comprising the steps of:
a. providing a first body comprising a first particulate material;
b. providing a second body comprising a second particulate material;
c. providing, between and contacting the first and second bodies, a third material, which differs from the first and the second materials, which will chemically react at a reaction temperature with at least one of the first and the second materials to form a fourth material; and
d. maintaining conditions, including temperature, at conditions such that:
i. the third material forms a continuous fluid phase and migrates and penetrates at least partially into at least one of the first and second bodies and a chemical reaction occurs with the third material and at least one of the first and the second materials, to form a continuous phase of the fourth material that penetrates at least partially across the interface between the first and second bodies; and
ii. at least one of the first and second particulate materials sinters.

51. The method of claim 50, the fourth material having a solidus temperature that is higher than the temperature at which the reaction occurs.

52. A method of providing a metal covering on a ceramic body comprising the steps of:
a. providing a body comprising a ceramic material;
b. providing a metal material, at least one of the metal and the ceramic materials being in a particulate form;
c. contacting the ceramic body at locations to be covered with a joining material, which differs from the ceramic and the metal materials, which joining material will chemically react at a reaction temperature with at least one of the ceramic and metal materials to form a fourth material;
d. contacting the metal material to the ceramic body at the locations to be covered, at which the joining material is present; and
e. maintaining conditions, including temperature, such that:
i. the joining material forms a continuous fluid phase and migrates and penetrates at least partially at least one of the ceramic body and metal material and a chemical reaction occurs with the joining material and at least one of the ceramic body and the metal material, to form a continuous phase of a fourth material that penetrates at least partially across the interface between the ceramic body and the metal material; and
ii. the at least one particulate material sinters.

53. The method of claim 52, the fourth material having a solidus temperature that is higher than the temperature at which the reaction occurs.

54. The method of claim 52, the metal comprising particulate material.

55. The method of claim 52, the ceramic material comprising particulate material.

56. A method of providing a ceramic covering on a metal body comprising the steps of:
a. providing a body comprising a metal material;
b. providing a ceramic material, at least one of the metal and the ceramic materials being in a particulate form;
c. contacting the metal body at locations to be covered with a joining material, which differs from the ceramic and the metal materials, which joining material will chemically react at a reaction temperature with at least one of the ceramic and metal materials to form a fourth material;
d. contacting the ceramic material to the metal body at the locations to be covered, at which the joining material is present; and
e. maintaining conditions, including temperature, such that:
i. the joining material forms a continuous fluid phase and migrates and penetrates at least partially at least one of the metal body and ceramic material and a chemical reaction occurs with the joining material and at least one of the metal body and the ceramic material, to form a continuous phase of a fourth material that penetrates at least partially across the interface between the metal body and the ceramic material; and
ii. the at least one particulate material sinters.

57. The method of claim 56, the fourth material having a solidus temperature that is higher than the temperature at which the reaction occurs.

58. The method of claim 56, the metal material comprising particulate material.

59. The method of claim 56, the ceramic material comprising particulate material.
